(19) United States
(12) Patent Application Publication
(10) Pub. No.: US 2025/0376002 A1
(43) Pub. Date: Dec. 11, 2025

(54) MIXING DOOR CONTROL STRATEGY, DYNAMIC CARBON DIOXIDE PURGE STRATEGY, AND FAN CONTROL BASED ON AIRFLOW AND NOISE LEVEL FOR A VEHICLE HEATING, VENTILATION, AND AIR CONDITIONING (HVAC) SYSTEM

(71) Applicant: Rivian IP Holdings, LLC, Irvine, CA (US)

(72) Inventors: Zachary Kyle MOUL, Hermosa Beach, CA (US); Ean Joshua HALL, Long Beach, CA (US); Dewashish PRASHAD, Irvine, CA (US)

(21) Appl. No.: 19/231,296

(22) Filed: Jun. 6, 2025

Related U.S. Application Data
(60) Provisional application No. 63/656,693, filed on Jun. 6, 2024.

(51) Int. Cl. B60H 1/00

(52) U.S. Cl. CPC B60H 1/00742; B60H 1/00021; B60H 1/008; B60H 2001/00092

(57) ABSTRACT

Embodiments relate to controlling a heating, ventilation, and air conditioning (HVAC) system of a vehicle to improve mixing door control, fan control across different intake modes, and/or carbon dioxide purging. Embodiments include determining a target temperature for a zone of an HVAC system of a vehicle. Embodiments include determining, for a mixing chamber of the HVAC system, a target position of a mixing door of the mixing chamber to achieve the target temperature for the zone based on a curve representing mixing chamber temperature versus mixing door position, wherein the curve is specific to the zone. Embodiments include instructing one or more components to move the mixing door to the target position.

### RELATED APPLICATION

This application claims the benefit of U.S. Provisional Application Ser. No. 63/656,693 filed Jun. 6, 2024, and entitled MIXING DOOR CONTROL STRATEGY, DYNAMIC CARBON DIOXIDE PURGE STRATEGY, AND FAN CONTROL BASED ON AIRFLOW AND NOISE LEVEL FOR A VEHICLE HEATING, VENTILATION, AND AIR CONDITIONING (HVAC) SYSTEM.

### INTRODUCTION

The present disclosure relates to controlling a heating, ventilation, and air conditioning (HVAC) system of a vehicle.

### SUMMARY

The present disclosure describes an approach for controlling a heating, ventilation, and air conditioning (HVAC) system of a vehicle to improve mixing door control, fan control across different intake modes, and/or carbon dioxide purging.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3 is schematic diagram showing components of a vapor compression heat transfer and/or cooling system in accordance with certain embodiments.

FIG. 4 illustrates an example of a mixing door control strategy for a vehicle HVAC system in accordance with certain embodiments.

FIG. 5 illustrates an example of a CO2 purge strategy for a vehicle HVAC system in accordance with certain embodiments.

FIG. 6 depicts a flow chart representing functionality associated with vehicle HVAC system control, in accordance with embodiments of the present disclosure.

FIG. 7 depicts another flow chart representing functionality associated with vehicle HVAC system control, in accordance with embodiments of the present disclosure.

FIG. 8 depicts another flow chart representing functionality associated with vehicle HVAC system control, in accordance with embodiments of the present disclosure.

### DETAILED DESCRIPTION

A vehicle's HVAC system may include multiple mixing chambers, such as corresponding to different zones (e.g., a left zone, right zone, and rear zone). Each mixing chamber may be associated with its own airflow and mixing characteristic(s), and may be associated with one or more mixing doors. When all zones are configured with the same target temperature, different mixing door positions may be required in order to achieve the individual target discharge temperatures. When the zones are configured with different target temperatures, significantly different mixing door positions may be required to achieve the individual target discharge temperatures. This behavior is due to the stratification across the evaporator and cabin condenser as well as the difference in flow path for full cold (e.g., evaporator only) and full hot (e.g., evaporator and cabin condenser).

Accordingly, certain techniques described herein involve characterizing the airflow mixing ratio for each zone when the zones are synchronized (e.g., configured with the same target temperature). Some techniques described herein involve characterizing the correction(s) required to offset the airflow imbalance created by differing temperature requests when the zones are not synchronized (e.g., configured with different target temperatures). Such characterizations may be stored in the form of curves, such as representing airflow mixing ratios and/or mixing door corrections for particular temperature values.

Additionally, when an HVAC's intake door is set to full recirculation, the HVAC system may be in its most efficient state, but the cabin carbon dioxide (CO2) levels may increase beyond a comfortable or optimal level. Existing CO2 purge techniques involve a fixed timer and a fixed purge duration that does not consider the total number of occupants. Furthermore, existing CO2 purge techniques may result in a fluctuation in the discharge temperature since the intake door is opening slightly, which causes a ripple effect in compressor performance.

Accordingly, techniques described herein involve estimating the amount of CO2generation based on occupants to better estimate when the cabin is at high CO2 levels, estimating the amount of fresh air purged based on the fresh air ratio for a given intake door position and the total cabin volume, and monitoring the discharge temperature drift and holding the intake door position when the discharge temperature has drifted too much (e.g., more than a threshold amount).

Furthermore, a vehicle HVAC system may have different modes such as fresh air mode and recirculation mode. Airflow and noise level may vary significantly between such modes even with the same configured target temperature. For example, in manual fan control, airflow and noise can vary significantly based on the intake door position since each fan level is directly associated with a blower pulse width modulation (PWM) percentage. In recirculation mode, there may be no air filter involved, so higher airflow may be achieved, but more noise may be generated since both the inlet and the outlet to the blower are open to the cabin. In fresh air mode, air may pass through an air filter, resulting in a greater airflow resistance compared to recirculation mode, and the airflow also has to overcome the pressure difference of forcing air into the cabin. The blower may be quieter in fresh air mode since only the outlet of the blower is open to the cabin.

Accordingly, certain techniques described herein involve creating different manual fan level blower PWM lookup tables for different modes such as fresh air and recirculation in order to balance the airflow and noise, resulting in the same physical and acoustic sensation in each intake mode.

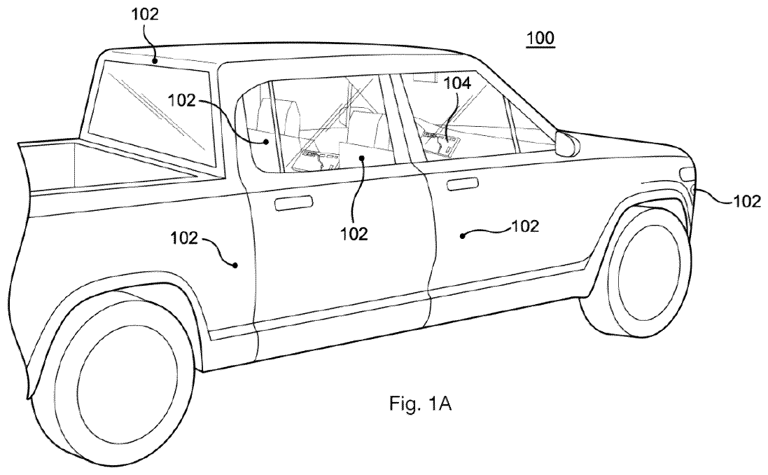

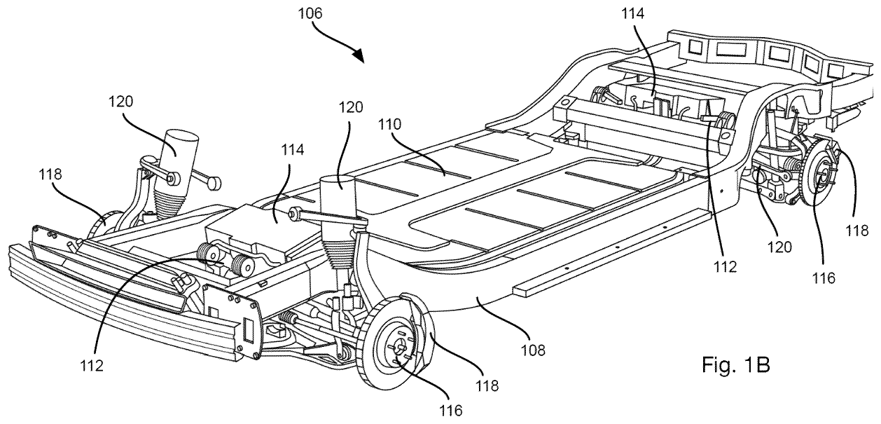

FIG. 1A illustrates an example vehicle 100. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (i.e., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by power electronics 114 of each drive unit 112. The power electronics 114 may include inverters configured to convert direct current (DC) from the battery 110 into alternating current (AC) supplied to the motors of the drive units 112. The power electronics 114 further facilitate operation of the motors of the drive units as generators to provide regenerative braking. The power electronics 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIG. 1B and in the discussion below, the vehicle 100 is a battery electric vehicle. However, the systems and methods disclosed herein may be used for any type of vehicle, including vehicles powered by an internal combustion engine (ICE), hybrid drivetrain, hydrogen fuel cell drivetrain, or other type of drivetrain that may have a portion that is idled during some modes of operation. For example, a front or rear differential of an all-wheel drive vehicle. In another example, in a hybrid drive train, an idled drive unit including an electric motor may be heated with waste heat from an ICE according to the approaches described herein.

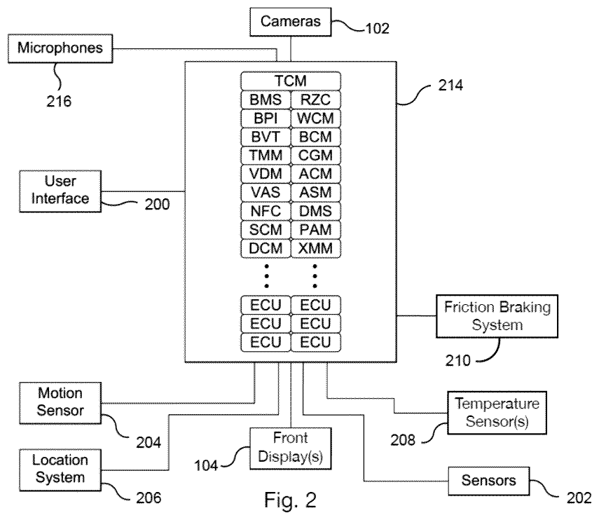

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204, and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of power electronics 114, temperature of each drive unit 112 and/or each motor of each drive unit 112, temperature of coolant fluid entering or leaving a coolant system, temperature of oil within a drive unit 112, or the temperature of any other component of the vehicle 100.

The components of the vehicle 100 may include a friction braking system 210. The friction braking system 210 may include any components of a hydraulic braking system, such as a rotor, brake pads, calipers, caliper pistons, a master cylinder coupled to the brake pedal and coupled to the caliper pistons by brake lines. The friction braking system 210 may further include a pump and/or valves for automatically applying hydraulic pressure to the caliper pistons. The friction braking system 210 may be implemented as a drum braking system or any friction braking system known in the art.

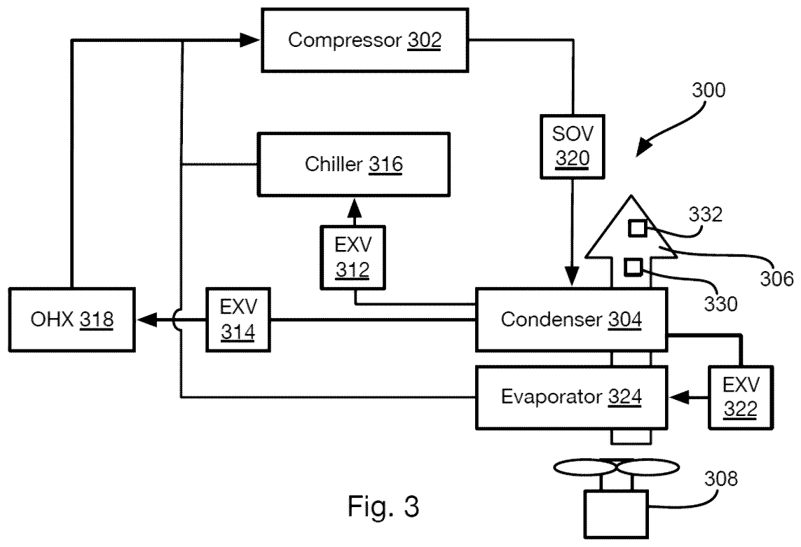

A control system 214 executes instructions to perform at least some of the actions or functions of the vehicle 100, including the functions described in relation to FIGS. 3 to 8. For example, as shown in FIG. 2, the control system 214 may include one or more electronic control units (ECUs) configured to perform at least some of the actions or functions of the vehicle 100, including the functions described in relation to FIGS. 3 to 8. In certain embodiments, each of the ECUs is dedicated to a specific set of functions. Each ECU may be a computer system, and each ECU may include functionality described below in relation to FIGS. 3 to 8.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfers data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for performing, for example, the operations and functions described in relation to FIGS. 3 to 8.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

The ECUs may include one or more ECUs that are configured to control the friction braking system 210. For example, the ECUs may include a traction control module, a stability control system, automated emergency braking (AEB) module, anti-lock braking system (ABS), adaptive cruise control module (ACC), and/or an automated driving assistance system (ADAS). The traction control module controls braking and acceleration to control wheel slip according to any approach known in the art. The traction control module may also control the torque applied at each wheel, i.e., torque vectoring. The stability control system controls braking and acceleration in order to avoid rollovers of the vehicle 100 according to any approach known in the art. The AEB module stops the vehicle 100 in a controlled manner response to predicted collisions according to any approach known in the art. The ABS modulates braking to maintain traction. The ACC maintains a speed of the vehicle while also maintaining a prescribed following distance with respect to other vehicles. The ADAS controls steering, acceleration, and braking of the vehicle 100 to arrive at a destination according to any self-driving approach known in the art.

Referring to FIG. 3, a vapor compression heat transfer system 300 (“system 300”) may be used to heat a cabin of the vehicle 100. The system 300 may therefore operate as a heat pump. In the description below, operation of the system 300 as a heat pump is described with the understanding that components of the system 300 may be switched over to function as a refrigeration system for cooling the cabin of the vehicle 100. The illustrated system 300 is exemplary only. Any heat pump system and/or refrigeration system known in the art, particularly those included in vehicles, may be used.

The system 300 includes a compressor 302 that compresses a refrigerant within the system 300, such as from a vapor to a liquid, which causes an increase in temperature of the refrigerant. The compressed refrigerant is conducted to a condenser 304. The condenser 304 transfers heat from the compressed refrigerant to the cabin of the vehicle 100. The condenser 304 may be located within the cabin or air flow 306 passing over the condenser 304 may be conducted into the cabin, such as by a fan 308.

The compressed refrigerant exits the condenser 304 and passes through one or more. expansion valves 312, 314. The expansion valves 312, 314 permit the compressed refrigerant to expand and thereby decrease in temperature. The expansion valves 312, 314 may have a range of positions defining the flow of compressed refrigerant through the expansion valves 312, 314. For example, the expansion valves 312, 314 may be implemented as electronic expansion valves (EXV) 312, 314. The expanded refrigerant exiting the EXVs 312, 314 may absorb heat from one or more sources. For example, the expanded refrigerant may pass through a chiller 316. The chiller 316 is a heat exchanger that facilitates the transfer of heat from a coolant of a thermal management system to the expanded refrigerant. The coolant may be circulated by the thermal management system around the battery 110, power electronics 114, and/or drive units 112 of the vehicle 100 to maintain these components in desired ranges.

The expanded refrigerant exiting the expansion valve 314 may pass through an outside heat exchanger 318. The outside heat exchanger 318 facilitates the transfer of heat from the environment of the vehicle 100 into the expanded refrigerant. The outside heat exchanger 318 may therefore be implemented as a radiator including an elongate folded tube with fins. The outside heat exchanger 318 may rely on passive air flow and/or may include a fan to force air flow over the radiator.

Expanded refrigerant exiting the EXVs 312, 314 may return to the compressor 302. In some embodiments, one or more shut off valves (SOV) 320 may be present in the system 300. The SOV 320 may have open and closed states with any intermediate state being traversed when transitioning between the open and closed states. In the illustrated embodiment, a SOV 320 is present between the outlet of the compressor 302 and the inlet of the condenser 304, but other arrangements are possible.

In some embodiments, the system 300 may simultaneously act as a heat pump and a refrigerator. For example, air circulated through the cabin may be cooled to remove moisture from the air in order to defog windows. Accordingly, an evaporator 324 and corresponding EXV 322 supplying expanded refrigerant to the evaporator 324 may also be present. Air flow over the evaporator 324 may be induced by the fan 308 or a separate fan. Expanded refrigerant may be received from a dedicated EXV 322 or one of the other EXVs 312, 314. For example, the evaporator 324 may be in series (e.g., upstream) of the OHX 318, and the expansion valve 322 may be used to control flow of refrigerant through both of the OHX 318 and the evaporator 324. In other embodiments, the evaporator 324 may be in series (e.g., upstream) of the OHX 318, and EXVs 314, 322 are present at the inlets of the OHX 318 and evaporator 324, respectively.

The system 300 may be partially controlled based outputs of a discharge temperature sensor 330 and an air speed sensor 332. In the description below, reference to a target discharge temperature may refer to a target for the output of the temperature sensor. Likewise, in the description below, references to a target air flow may refer to a target output of the air speed sensor 332, which may be resolved to a mass flow rate of the air flow 306.

The system 300 may be controlled to achieve the target discharge temperature and the target air flow using any approach known in the art. Specifically, the speed of the compressor 302, speed of the fan 308, degree of opening of one or more of the EXVs 312, 314, 322, and opening or closing of the SOV 320 may be controlled using any approach known in the art in order to achieve the target discharge temperature and target air flow.

The system 300 is exemplary only. A target discharge temperature and target air flow may also be achieved by other types of systems, such as vapor compression refrigeration system providing cooling with a heater core or resistive element providing heating, the heater core being heated with air from an internal combustion engine or other source of heat.

In some embodiments, the system 300 may include multiple mixing chambers, such as associated with mixing doors. The mixing doors may be closed or open to varying degrees, such as to achieve particular results for multiple zones (e.g., left, right, and rear).

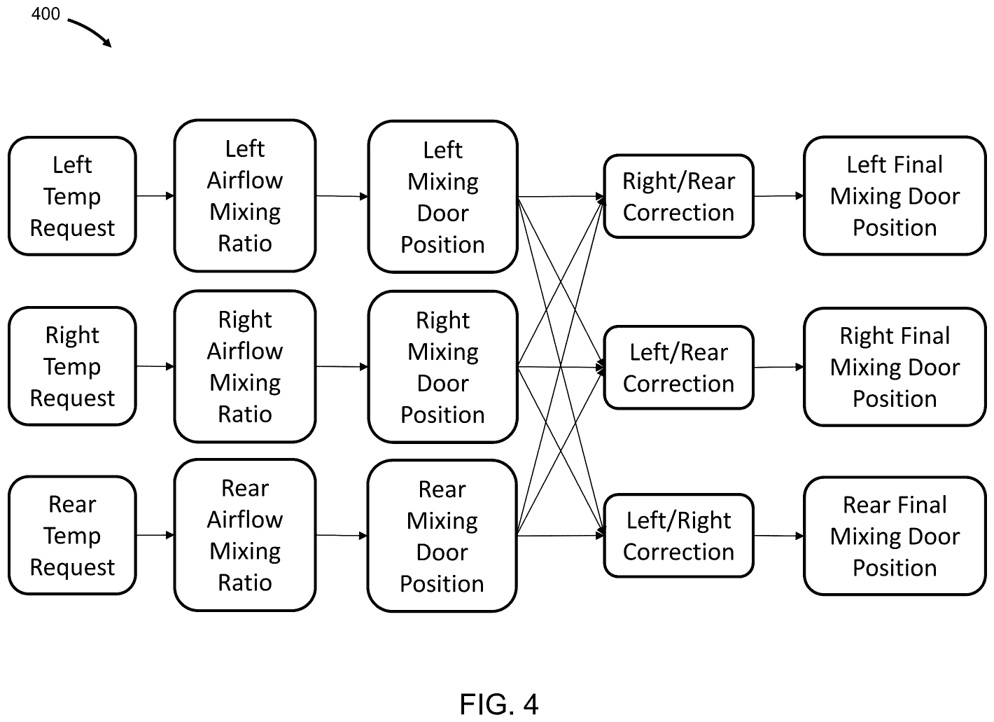

Referring to illustration 400 of FIG. 4, each of a plurality of zones (e.g., front left, front right, and rear) may be associated with a unique curve (e.g., quadratic curve) to show how the cabin condenser and evaporator are mixing, such as indicating that a certain ratio of airflow (e.g., regardless of the amount of airflow), such as based on mixing door position(s), will go to the cabin condenser and the evaporator (e.g., the ratio may represent condenser/evaporator or evaporator/condenser). Thus, a feed forward term (e.g., the airflow mixing ratio) to get a mixing chamber outlet temperature is determined for each zone, and feedback may be performed on the feed forward term for further tuning to determine a mixing door position (e.g., for each zone). The curve may be a quadratic curve representing mixing chamber temperature (e.g., the y axis) versus mixing door position (e.g., the x axis). The curve may be different for each zone, such as due to the configuration of the HVAC system. The use of such a feed forward term may enable a reduction of the number of temperature sensors, thereby resulting in cost savings.

Furthermore, in some embodiments, the impact of mixing door positions for other zones on a mixing door position for each given zone may be determined. For example, in connection with determining a left mixing door position based on a left mixing ratio to achieve a temperature for the left zone, a correction to the left mixing door position may be determined based on the positions of the right mixing door and/or the rear mixing door in order to determine a final left mixing door position. Such corrections (e.g., stored in the form of a different quadratic curve that can be used to look up such values based on given data points such as a target temperature for a zone and/or the mixing door positions of other zones) may allow for accurately achieving target temperatures in each given zone in a manner that takes into account the impact of other zones' mixing door positions on the given zone's mixing door position.

Advantageously, utilizing curves described herein (e.g., rather than large lookup tables) may be more efficient and accurate for determining mixing door positions (e.g., a target mixing door position to achieve a target temperature for a particular zone), and may be utilized to determine accurate results regardless of whether the airflow in a given zone is known.

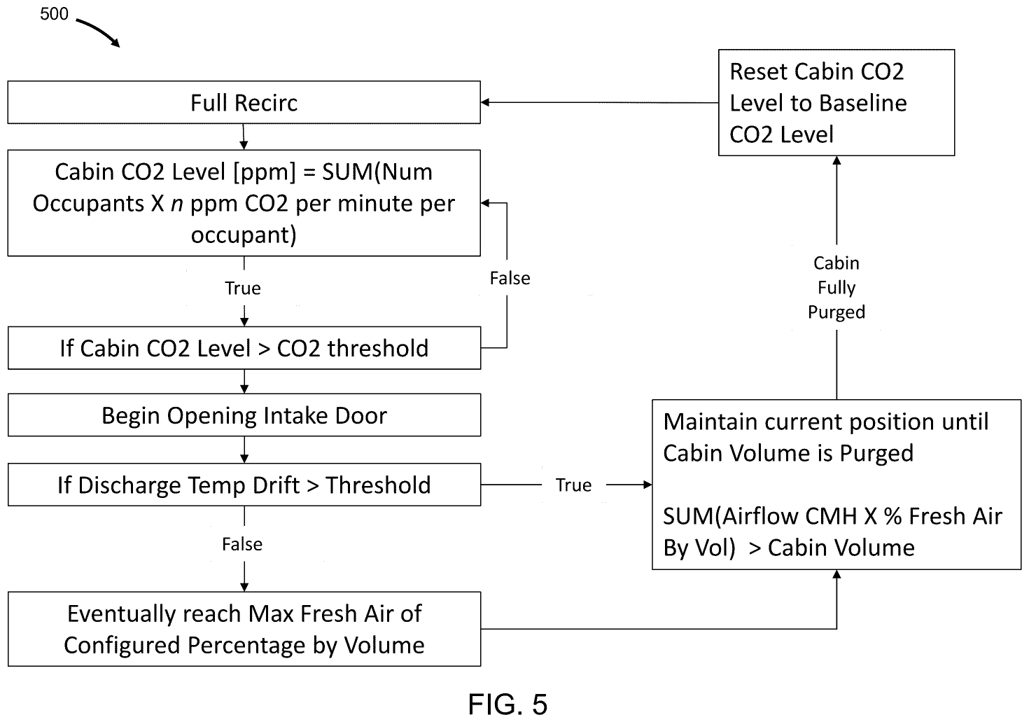

With reference to illustration 500 of FIG. 5, certain techniques described herein involve utilizing the number of occupants of the vehicle to dynamically purge CO2. For example, during full recirculation mode, a formula of n parts per million (PPM) of CO2 per minute per occupant (e.g., n may be a configurable value) may be used to determine a cabin CO2 level (e.g., in PPM). The number of occupants of the vehicle may be determined based on one or more sensors and/or cameras associated with the vehicle and/or based on user input. In some aspects there may be a minimum number of occupants presumed in one or more particular vehicle modes. For example, when “camping mode” or “pet mode” is enabled for the vehicle, the number of occupants may be set to a minimum of n occupants (e.g., n may be configurable), such as one occupant or two occupants, even if no occupants are detected via one or more sensors or other techniques (e.g., if the detected number of passengers is greater than n then the number of occupants may be set to the detected number, while the number of occupants may otherwise be set to n). In one example, in all vehicle modes the minimum number of presumed occupants is one, while in “camping mode” or “pet mode” the minimum number of presumed occupants is two. Such a minimum number of presumed occupants may ensure effective CO2 purging even when no occupants are otherwise detected.

The cabin CO2 level may be compared to a threshold (e.g., which may be configurable) and, if the cabin CO2 level exceeds the threshold, the intake door may begin to be opened (if the cabin CO2 level does not exceed the threshold, then the cabin CO2 level may continue to be computed over time using the formula until such time as it exceeds the threshold).

After beginning to open the intake door, if the discharge temperature drift exceeds a threshold temperature drift amount (e.g., which may be configurable), then the current position of the intake door may be maintained until the cabin volume is purged. The cabin volume may be determined to be purged based on computing a sum of the airflow cubic meters per hour (CMH) times the percentage of fresh air by volume and determining whether the sum meets and/or exceeds the cabin volume (e.g., at which point the cabin volume may be determined to be purged). After purging the cabin volume, the cabin CO2 level may be reset to a baseline value to again begin incrementing based on the formula discussed above for determining the cabin CO2 level over time based on the number of occupants.

After beginning to open the intake door, if the discharge temperature drift does not exceed the threshold temperature drift amount, then eventually a maximum fresh air of a particular percentage by volume (e.g., the particular percentage may be configurable) may be reached, at which point the current position of the intake door may be maintained until the cabin volume is purged, and then the cabin CO2 level may be reset to the baseline value.

Techniques described herein for CO2 purging are more dynamic and accurate than other techniques, such as those that are based on timers, as embodiments of the present disclosure are cabin CO2 level resolved, occupancy resolved, cabin temperature resolved, and vehicle resolved (e.g., because of the cabin volume being used in the process).

Additionally, some embodiments involve creating different manual fan level blower pulse width modulation (PWM) lookup tables for different modes such as fresh air and recirculation in order to balance the airflow and noise, resulting in the same physical and acoustic sensation in each intake mode. For example, while some existing techniques involve the use of fixed blower PWM percentages for multiple zones for both fresh air and recirculation modes, these techniques may result in differing airflow and noise levels when changing between modes. This is because recirculation mode involves no pressure difference as a result of air being pulled from the cabin and recirculated into the cabin but is louder due to both the inlet and outlet being exposed to the cabin while fresh air mode involves taking air from outside the cabin and forcing it inside the cabin, thereby creating a pressure differential, while being quieter due to only the outlet being exposed to the cabin.

Techniques described herein overcome these challenges by configuring different PWMs for each mode, such as for each zone. For example, such a configuration may involve associating each fan level with a PWM for recirculation mode and a PWM for fresh air mode, such as for each zone and/or combination of zones (e.g., front only, front and rear, and/or the like). For example, in some embodiments, a higher PWM may be used to achieve a particular approximate cubic meters per hour (CMH) airflow value or range for fresh air mode as compared to a lower PWM value that may be used to achieve the particular approximate CMH airflow value or range for recirculation mode (e.g., because recirculation mode is generally more efficient). Such configured PWMs may also achieve a noise level, such as in decibels (db), that is similar (e.g., with a range of a few decibels) across recirculation mode and fresh air mode for each fan level.

In some embodiments, for one or more certain fan levels (e.g., the highest fan level) performance is prioritized over consistency in airflow and noise level across modes, such as choosing the PWM that achieves the best temperature result (and/or otherwise the highest configurable PWM) for both modes for such fan levels. In some cases, PWM is achieved via intake door resolve.

In some aspects, changes to the blower PWM (e.g., based on a change from recirculation mode to fresh air mode or vice versa) may be performed at a rate that is determined based on an amount of time it takes to open or close the intake door. For example, if a change in intake mode (requiring opening or closing the intake door) results in a change in blower PWM (e.g., based on a manual fan level blower PWM lookup table as described herein), the change in blower PWM may be made gradually at a speed that results in the change being complete when the intake door has completely opened or completely closed. Such a technique may result in a more gradual shift in blower PWM that occurs in tandem with the opening or closing of the intake door, thereby causing less of a noticeable audible change.

A PWM value determined using techniques described herein may be used to control a blower/fan accordingly, such as by providing instructions to the blower according to the determined PWM value.

Notably, techniques described herein may make the differences in airflow and noise level less noticeable or unnoticeable across fresh air mode and recirculation mode.

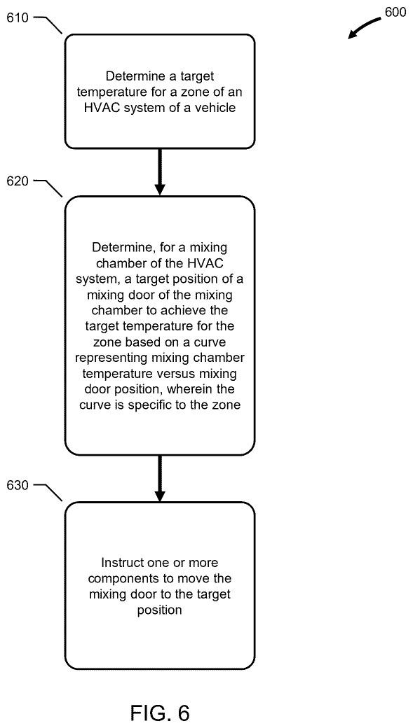

FIG. 6 depicts a flow chart 600 representing functionality associated with vehicle HVAC system control, in accordance with embodiments of the present disclosure. For example, the functionality described with respect to flow chart 600 may be performed in conjunction with or independently of functionality described above with respect to FIGS. 1-5. In one example, the functionality described with respect to flow chart 600 may be performed by control system 214 of FIG. 2.

In certain embodiments, functionality associated with flow chart 600 may include functional blocks 610, 620, and 630. In other embodiments, these functional blocks may be arranged in a different order, certain functional blocks may be omitted, other functional blocks may be added, etc.

At 610, a target temperature for a zone of an HVAC system of a vehicle is determined.

At 620, for a mixing chamber of the HVAC system, a target position is determined of a mixing door of the mixing chamber to achieve the target temperature for the zone based on a curve representing mixing chamber temperature versus mixing door position, wherein the curve is specific to the zone.

At 630, one or more components are instructed to move the mixing door to the target position.

In some aspects, the determining of the target position of the mixing door comprises using the curve as a feed forward term defining an airflow mixing ratio for the zone.

In certain aspects, the determining of the target position of the mixing door is further based on one or more positions of one or more other mixing doors of one or more other mixing chambers of the HVAC system.

In some aspects, the determining of the target position of the mixing door involves determining a positional correction for the mixing door based on the one or more positions of the one or more other mixing doors.

In certain aspects, the positional correction is determined based on an additional curve.

In some aspects, the determining of the target position of the mixing door is not based on any determined airflow value for the zone.

In certain aspects, a different zone of the HVAC system is associated with a different curve representing corresponding mixing chamber temperature versus corresponding mixing door position for the different zone.

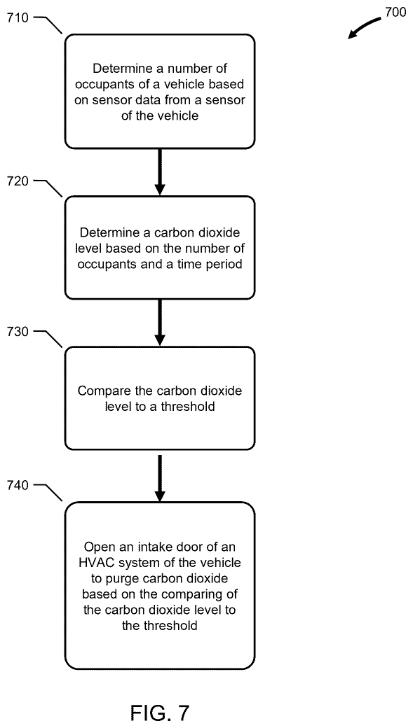

FIG. 7 depicts a flow chart 700 representing functionality associated with vehicle HVAC system control, in accordance with embodiments of the present disclosure. For example, the functionality described with respect to flow chart 700 may be performed in conjunction with or independently of functionality described above with respect to FIGS. 1-5. In one example, the functionality described with respect to flow chart 700 may be performed by control system 214 of FIG. 2.

In certain embodiments, functionality associated with flow chart 700 may include functional blocks 710, 720, 730, and 740. In other embodiments, these functional blocks may be arranged in a different order, certain functional blocks may be omitted, other functional blocks may be added, etc.

At 710, a number of occupants of a vehicle is determined based on sensor data from a sensor of one or more sensors of the vehicle.

At 720, a carbon dioxide level is determined based on the number of occupants and a time period.

At 730, the carbon dioxide level is compared to a threshold.

At 740, an intake door of an HVAC system of the vehicle is opened to purge carbon dioxide based on the comparing of the carbon dioxide level to the threshold.

In some aspects, the determining of the carbon dioxide level involves applying a formula that specifies an amount of carbon dioxide that accumulates per occupant in a given time period.

Certain aspects further comprise determining a discharge temperature drift during the opening of the intake door and stopping the opening of the intake door at a particular position based on the discharge temperature drift.

In some aspects, the stopping of the opening of the intake door is based on determining that the discharge temperature drift exceeds a threshold.

Certain aspects further comprise keeping the intake door open until determining that a cabin carbon dioxide volume has been purged.

In some aspects, the determining that the cabin carbon dioxide volume has been purged is based on computing a sum of an airflow cubic meters per hour times a percentage of fresh air by volume and determining whether the sum meets or exceeds the cabin carbon dioxide volume.

Certain aspects further comprise closing the intake door after the determining that the cabin carbon dioxide volume has been purged.

Some aspects further comprise resetting the carbon dioxide level to a baseline value after the closing of the intake door.

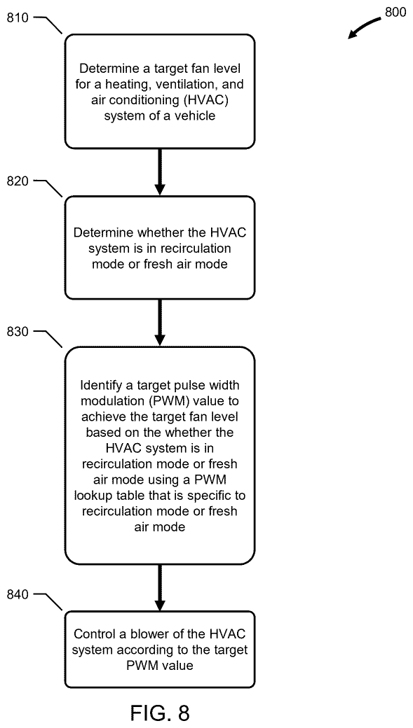

FIG. 8 depicts a flow chart 800 representing functionality associated with vehicle HVAC system control, in accordance with embodiments of the present disclosure. For example, the functionality described with respect to flow chart 800 may be performed in conjunction with or independently of functionality described above with respect to FIGS. 1-5. In one example, the functionality described with respect to flow chart 800 may be performed by control system 214 of FIG. 2.

In certain embodiments, functionality associated with flow chart 800 may include functional blocks 810, 820, 830, and 840. In other embodiments, these functional blocks may be arranged in a different order, certain functional blocks may be omitted, other functional blocks may be added, etc.

At 810, a target fan level for a heating, ventilation, and air conditioning (HVAC) system of a vehicle is determined.

At 820, a determination is made of whether the HVAC system is in recirculation mode or fresh air mode;

At 830, a target pulse width modulation (PWM) value to achieve the target fan level is determined based on the whether the HVAC system is in recirculation mode or fresh air mode using a PWM lookup table that is specific to recirculation mode or fresh air mode.

At 840, a blower of the HVAC system is controlled according to the target PWM value.

In some aspects, the target fan level is for a particular zone of the HVAC system, and wherein the PWM lookup table is specific to the particular zone.

Certain aspects further comprise determining that the HVAC system has changed from recirculation mode to fresh air mode and, in response to the that determining that the HVAC system has changed from the recirculation mode to the fresh air mode, identifying an updated target PWM value to achieve the target fan level using a corresponding PWM lookup table that is specific to the fresh air mode. The blower of the HVAC system may be controlled according to the updated target PWM value.

Some aspects further comprise determining an updated target fan level for the HVAC system, determining that the updated target fan level is a highest fan level, and controlling the blower of the HVAC system according to a configured PWM value for the highest fan level based on the determining that the updated target fan level is the highest fan level.

In certain aspects, the recirculation mode and the fresh air mode are associated with separate PWM lookup tables that are different from one another, and wherein the PWM lookup table is one of the separate PWM lookup tables.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

Aspects of the present disclosure may take the form of an entirely hardware embodiment, an entirely software embodiment (including firmware, resident software, micro-code, etc.) or an embodiment combining software and hardware aspects that may all generally be referred to herein as a “circuit,” “module” or “system.”

Various aspects of the present disclosure are described by narrative text, flowcharts, block diagrams of computer systems and/or block diagrams of the machine logic included in computer program product (CPP) embodiments. With respect to any flowcharts, depending upon the technology involved, the operations can be performed in a different order than what is shown in a given flowchart. For example, again depending upon the technology involved, two operations shown in successive flowchart blocks may be performed in reverse order, as a single integrated step, concurrently, or in a manner at least partially overlapping in time.

A computer program product embodiment (“CPP embodiment” or “CPP”) is a term used in the present disclosure to describe any set of one, or more, storage media (also called “mediums”) collectively included in a set of one, or more, storage devices that collectively include machine readable code corresponding to instructions and/or data for performing computer operations specified in a given CPP claim. A “storage device” is any tangible device that can retain and store instructions for use by a one or more computer processing devices. Without limitation, the computer readable storage medium may be an electronic storage medium, a magnetic storage medium, an optical storage medium, an electromagnetic storage medium, a semiconductor storage medium, a mechanical storage medium, or any suitable combination of the foregoing. Certain types of storage devices that include these mediums include: diskette, hard disk, random access memory (RAM), read only memory (ROM), erasable programmable read only memory (EPROM or Flash memory), static random access memory (SRAM), compact disc read only memory (CD-ROM), digital versatile disk (DVD), memory stick, floppy disk, mechanically encoded device (such as punch cards or pits/lands formed in a major surface of a disc) or any suitable combination of the foregoing. A computer readable storage medium, as that term is used in the present disclosure, refers to non-transitory storage rather than transitory signals per se, such as radio waves or other freely propagating electromagnetic waves, electromagnetic waves propagating through a waveguide, light pulses passing through a fiber optic cable, electrical signals communicated through a wire, and/or other transmission media. As will be understood by those of skill in the art, data is typically moved at some occasional points in time during normal operations of a storage device, such as during access, de-fragmentation or garbage collection, but the storage device remains non-transitory during these processes because the data remains non-transitory while stored.

While the foregoing is directed to embodiments of the present disclosure, other and further embodiments may be devised without departing from the basic scope thereof, and the scope thereof is determined by the claims that follow.

What is claimed is:

1. A method for vehicle heating, ventilation, and air conditioning (HVAC) mixing control, comprising:
determining a target temperature for a zone of an HVAC system of a vehicle;
determining, for a mixing chamber of the HVAC system, a target position of a mixing door of the mixing chamber to achieve the target temperature for the zone based on a curve representing mixing chamber temperature versus mixing door position, wherein the curve is specific to the zone; and
instructing one or more components to move the mixing door to the target position.

2. The method of claim 1, wherein the determining of the target position of the mixing door comprises using the curve as a feed forward term defining an airflow mixing ratio for the zone.

3. The method of claim 1, wherein the determining of the target position of the mixing door is further based on one or more positions of one or more other mixing doors of one or more other mixing chambers of the HVAC system.

4. The method of claim 3, wherein the determining of the target position of the mixing door involves determining a positional correction for the mixing door based on the one or more positions of the one or more other mixing doors.

5. The method of claim 4, wherein the positional correction is determined based on an additional curve.

6. The method of claim 1, wherein the determining of the target position of the mixing door is not based on any determined airflow value for the zone.

7. The method of claim 1, wherein a different zone of the HVAC system is associated with a different curve representing corresponding mixing chamber temperature versus corresponding mixing door position for the different zone.

8. A vehicle comprising:
a heating, ventilation, and air conditioning (HVAC) system;
one or more sensors;
one or more processors; and
a memory storing instructions that, when executed by the one or more processors, cause the one or more processors to:
determine a number of occupants of the vehicle based on sensor data from a sensor of the one or more sensors;
determine a carbon dioxide level based on the number of occupants and a time period;
compare the carbon dioxide level to a threshold; and
open an intake door of the HVAC system to purge carbon dioxide based on the comparing of the carbon dioxide level to the threshold.

9. The vehicle of claim 8, wherein the determining of the carbon dioxide level involves applying a formula that specifies an amount of carbon dioxide that accumulates per occupant in a given time period.

10. The vehicle of claim 9, wherein the instructions, when executed by the one or more processors, further cause the one or more processors to:
determine a discharge temperature drift during the opening of the intake door; and
stop the opening of the intake door at a particular position based on the discharge temperature drift.

11. The vehicle of claim 10, wherein the stopping of the opening of the intake door is based on determining that the discharge temperature drift exceeds a threshold.

12. The vehicle of claim 8, wherein the instructions, when executed by the one or more processors, further cause the one or more processors to keep the intake door open until determining that a cabin carbon dioxide volume has been purged.

13. The vehicle of claim 12, wherein the determining that the cabin carbon dioxide volume has been purged is based on computing a sum of an airflow cubic meters per hour times a percentage of fresh air by volume and determining whether the sum meets or exceeds the cabin carbon dioxide volume.

14. The vehicle of claim 12, wherein the instructions, when executed by the one or more processors, further cause the one or more processors to close the intake door after the determining that the cabin carbon dioxide volume has been purged.

15. The vehicle of claim 14, wherein the instructions, when executed by the one or more processors, further cause the one or more processors to reset the carbon dioxide level to a baseline value after the closing of the intake door.

16. A non-transitory computer readable medium comprising instructions that, when executed by one or more processors of a computing system, cause the computing system to:
determine a target fan level for a heating, ventilation, and air conditioning (HVAC) system of a vehicle;
determine whether the HVAC system is in recirculation mode or fresh air mode;
identify a target pulse width modulation (PWM) value to achieve the target fan level based on the whether the HVAC system is in recirculation mode or fresh air mode using a PWM lookup table that is specific to recirculation mode or fresh air mode; and
control a blower of the HVAC system according to the target PWM value.

17. The non-transitory computer readable medium of claim 16, wherein the target fan level is for a particular zone of the HVAC system, and wherein the PWM lookup table is specific to the particular zone.

18. The non-transitory computer readable medium of claim 16, wherein the instructions, when executed by the one or more processors, further cause the computing system to:
determine that the HVAC system has changed from recirculation mode to fresh air mode;
in response to the that determining that the HVAC system has changed from the recirculation mode to the fresh air mode, identify an updated target PWM value to achieve the target fan level using a corresponding PWM lookup table that is specific to the fresh air mode; and
control the blower of the HVAC system according to the updated target PWM value.

19. The non-transitory computer readable medium of claim 16, wherein the instructions, when executed by the one or more processors, further cause the computing system to:
determine an updated target fan level for the HVAC system;
determine that the updated target fan level is a highest fan level; and
controlling the blower of the HVAC system according to a configured PWM value for the highest fan level based on the determining that the updated target fan level is the highest fan level.

20. The non-transitory computer readable medium of claim 16, wherein the recirculation mode and the fresh air mode are associated with separate PWM lookup tables that are different from one another, and wherein the PWM lookup table is one of the separate PWM lookup tables.
